(19) United States
(12) Patent Application Publication
(10) Pub. No.: US 2023/0221710 A1
(43) Pub. Date: Jul. 13, 2023

(54) METHOD AND SYSTEM FOR QUALITY INSPECTION

(71) Applicants: Frederike Wartke, Monheim (DE); Stanislaus Müller, Neuss (DE)

(72) Inventors: Frederike Wartke, Monheim (DE); Stanislaus Müller, Neuss (DE)

(21) Appl. No.: 18/096,556

(22) Filed: Jan. 12, 2023

(30) Foreign Application Priority Data
Jan. 13, 2022 (EP) 22151276.7

(51) Int. Cl. G05B 19/418; G06F 16/2458

(52) U.S. Cl. CPC G05B 19/41875; G06F 16/2471; G05B 2219/42152

(57) ABSTRACT

A computer-implemented method for quality inspection of a component of a manufacturing device includes obtaining operational data relating to operation of the manufacturing device. The operational data includes a time series of one or more physical properties of the manufacturing device. Status data relating to a component of the manufacturing device is obtained. The status data includes events relating to and/or characteristic properties relevant for utilization of the component within the manufacturing device. The computer-implemented method includes labelling one or more subsets of the operational data by associating one or more of the events and/or characteristic properties to the one or more subsets and providing the one or more subsets as labelled training data for training a machine learning model. The machine learning model serves for outputting a quality indicator based on the labelled training data input. The trained machine learning model is provided for quality inspection.

This application claims the benefit of European Patent Application No. EP 22151276.7, filed on Jan. 13, 2022, which is hereby incorporated by reference in its entirety.

### TECHNICAL FIELD

The present embodiments relate to production systems and higher-level information systems.

### BACKGROUND

Industrial connectors establish a connection between a production system and a higher-level information system based on a gateway solution. Siemens® provides a standard way to gather machine data from control systems, third-party CNC controls, and automation technology. The service consists of consulting, implementation, and maintenance to provide seamless data transfer. The connectivity management and monitoring software running inside a gateway connecting the production system with the higher level information system may be hosted on any IPC or Virtual Machine that, for example, runs Linux Debian 9 or 10 and Docker CE. The service may also run in a virtual machine. To run the service in a virtual machine, a VMware server (e.g., supporting Debian 10) is used.

### SUMMARY

The scope of the present invention is defined solely by the appended claims and is not affected to any degree by the statements within this summary.

Process data on a manufacturing device of a production system may be continuously recorded by a gateway. This process data may be stored in a database as a time series (e.g., using InfluxDB). However, the process sequences of a manufacturing device, such as a machine tool, is not continuous, but divided into individual orders, workpieces, and processing steps. In addition, individual operations are performed with different components (e.g., different machine tools). In order to optimizations the operation of the production system and the manufacturing device, for example, and to carry out predictive maintenance or to detect wear, etc., operational data relating to a specific processing step and/or to a specific component and an indication relating to quality, component, and the like are to be provided.

Currently, the operational data may be recorded directly as individual measurements edge (e.g., using NC-trace). But then, no further adjustments may be made afterwards. Alternatively, a user may continuously store the operational data on his preferred storage platform. Then, it is possible to search for trigger values within the operational data and visualize the data for a time period selected. However, this requires manual work and is to be implemented for each manufacturing device individually. Collecting operational data of similar processes is thus not possible or becomes very tedious.

It is an object of the present invention to prepare operational data in such a way that individual process sections or stages can be selected, visualized and/or used as input data for machine learning models.

The present embodiments may obviate one or more of the drawbacks or limitations in the related art. For example, a computer-implemented method for quality inspection of a component of a manufacturing device is provided. The method includes the act of obtaining operational data relating to the operation of the manufacturing device, the operational data including a time series of one or more physical properties of the manufacturing device. The method includes the act of obtaining status data relating to a component of the manufacturing device, the status data including events relating to and/or characteristic properties relevant for the utilization of the component within the manufacturing device. The method includes the act of labelling one or more subsets of the operational data by associating one or more of the events and/or characteristic properties to the one or more subsets. The method includes the act of providing the one or more subsets as labelled training data for training a machine learning model. The machine learning model serves for outputting a quality indicator based on the labelled training data input. The method includes the act of providing the trained machine learning model for quality inspection.

As another example, an apparatus operative to perform the method acts is provided. The apparatus may include a processor and a memory.

### BRIEF DESCRIPTION OF THE DRAWINGS

FIG. 1 shows one embodiment of a production system including a tool, a tool measurement and/or presetting device, a tool storage device, and a machine tool.

FIG. 2 shows one embodiment of a machine tool and a tool measuring device, both connected to a gateway and transmitting data to the gateway and a higher-level information system.

FIG. 3 shows examples of clients on a machine tool and a tool measuring device transmitting data to one or more servers of a gateway.

FIG. 4 shows an example of the augmentation of operational data with status data.

FIG. 5 shows an example of the training of a machine learning model based on operational data.

FIG. 6 shows an example of the inference of a quality indicator based on operational data input in the trained machine learning model.

FIG. 7 shows an example of the usage of the quality indicator in a production system.

### DETAILED DESCRIPTION

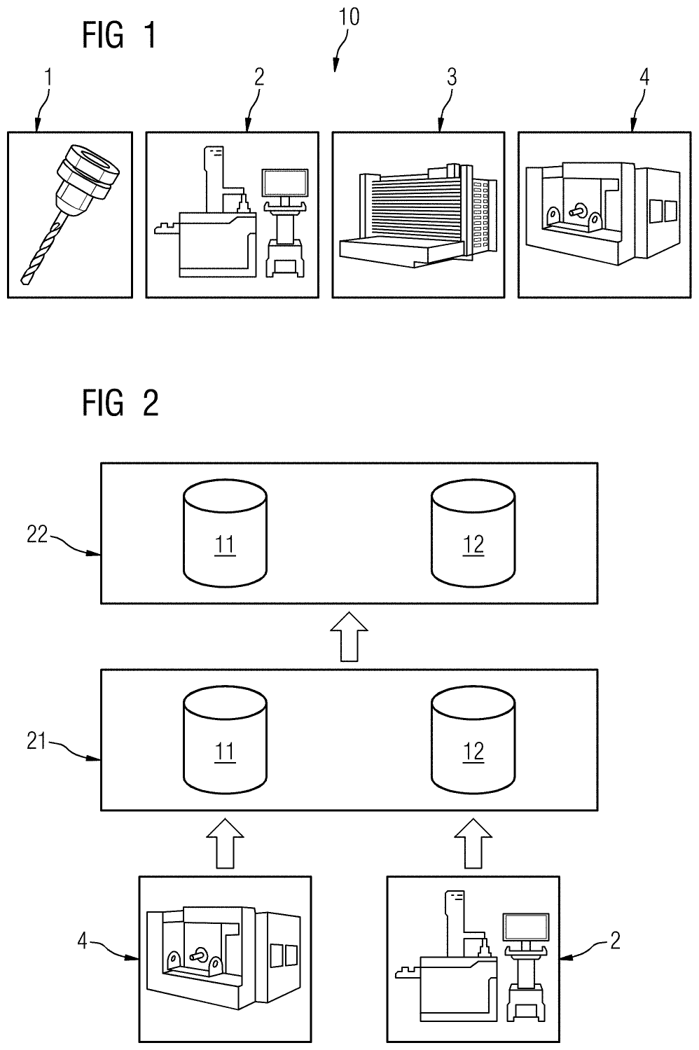

As shown in FIG. 1, one embodiment of a production system 10 may include a machine tool 4 that is controlled via computerized numerical control (e.g., a CNC machine tool also referred to NC control). The production system 10 includes a tool presetting and/or tool measuring apparatus 2 that is configured for measuring and/or presetting a tool 1. The tool presetting and/or tool measuring apparatus 2 is configured to create and/or determine at least one tool data set (e.g., a tool presetting data set, a tool measuring data set, and/or a tool processing data set) of the tool 1. The tool 1 may, for example, be a milling tool such as a ball nose end mill, a conical ball end, an end mill, an end mill corner rounding, or an angle head cutter.

The tool storage device 3 includes at least one tool storage element (e.g., a depository, a suspension, a clip, a stand, or the like) for a storage (e.g., a temporary fixation) of the tool 1.

In a loading and processing step, the machine tool 4 is loaded (e.g., from tool storage device 3 or presetting and/or tool measuring apparatus 2) with the tool 1, and then, a workpiece, not shown, is processed with the machine tool 4 and the tool 1 (e.g., in one or more process sections or stages or steps). After completion of processing of the workpiece with the tool 1, the tool 1 is unloaded from the machine tool 4 and stored in storage device 3, and/or measured, and/or preset by tool presetting and/or measuring device 2. Alternatively, after completion of processing of the one or more workpieces, the tool remains in the machine tool 4 until the next usage (e.g., for processing of another workpiece).

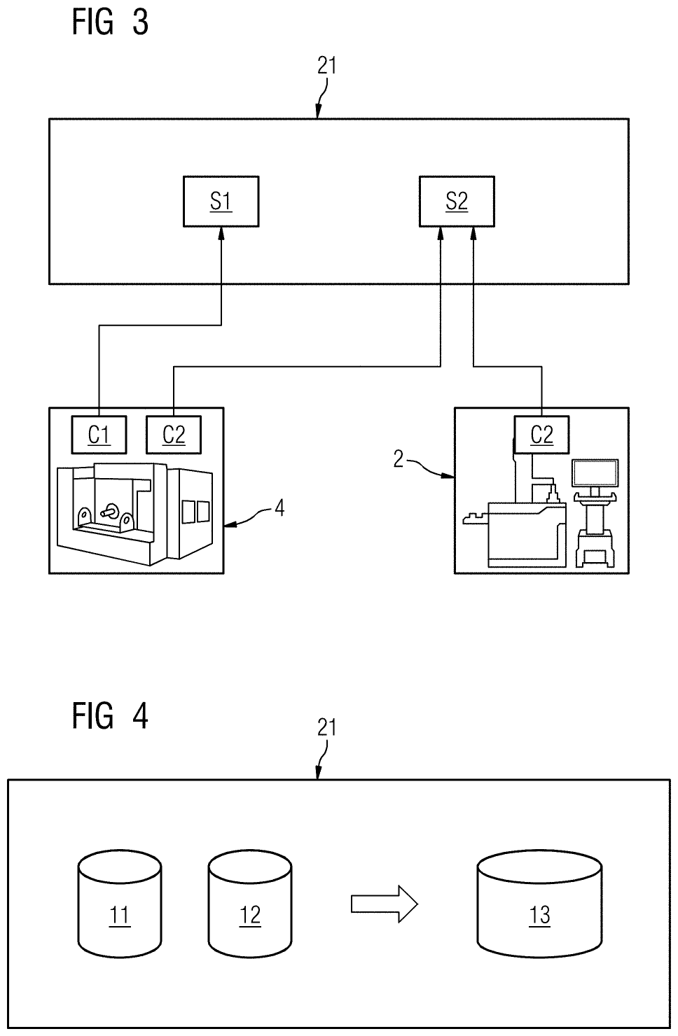

Turning to FIG. 2 and FIG. 3, respectively, a gateway 21 may be implemented in software and may be installed on a computer (e.g., an industrial PC, IPC, or edge device) that establishes the connection between the various manufacturing devices in the production system and a higher-level information system 22. A client C1, C2 may be installed on a machine tool 4, such as SINUMERIK, in order to connect the machine tool 4 to the gateway 21. The gateway 21 in that case serves as a server to the client on the machine tool 4. In other words, the gateway 21 includes one or more servers communicatively coupled to the one or more clients on the one or more manufacturing devices.

The gateway 21 may thus include a server that enables communication with manufacturing devices in the production system. In other words, a gateway 21 may be connected to a plurality of manufacturing devices of a production system. Hence, multiple data sources such as SINUMERIK 840D control systems, of a machine tool, or other third-party control systems may be provided, as shown in FIGS. 2 and 3.

High-frequency data acquisition in the interpolation or servo cycle of the control system of the manufacturing device may be provided (e.g., according to a configuration about every 10 ms and 2 ms). For example, the following variables may be recorded: NC-/PLC-variables, Global user data, Servo variables. This operational data may be recorded continuously or at specific points of the NC program (e.g., triggered by a start and stop condition). These conditions may be configured for data acquisition with the client C1, C2.

The gateway's 21 file transfer provides an application interface to access files located on connected manufacturing device 2, 4. This interface may be based on the standard protocol such as WebDAV. This interface allows to create, write, delete, rename, and read files and directories. This interface also allows to estimate file attributes: file size and date/time of the last change. The gateway 21 does not require a local storage for file transfer. The gateway 21 may accesses files directly on the machines. The WebDAV protocol is, for example, based on the HTTP protocol and/or is encrypted (e.g., with TLS 1.2/1.3). Thus, it is possible to access files of the connected manufacturing devices, such as machine tool 4 or apparatus 2. For the control system, it is possible to access the files from the NC as well as files from the HMI component. Thus, a software may be provided to perform inventory management on the server S1, S2 on the gateway that is connected to the one or more manufacturing device (e.g., machine tool 4). For machine tools, such a software may manage the complete tool circuit within a production system, as described in connection with FIG. 1. This software facilitates resource optimization and reduces downtimes by providing optimized master data, correction (e.g., offset) data, and OEM tool data. This software also supports tool management and tool handling, or component management in general. Within this software, there are a number of options to store a tool. The tool may, for example, be located on a machine tool, or the tool may be stored in a container, such as the storage device 3, also referred to as assembly container.

For example, as soon as an instance of a tool is created using the presetting and/or measurement device 2, the tool may be placed in the assembly container 3. The assembly state of a tool 1 may be, for example, to be obtained, to be overhauled, to be assembled, to be measured, or to be provided. Tools 1 may also be unloaded from a machine tool 4 to a container or be discarded from further usage. Further, the assembly state of a tool may be set to a state that prevents further usage of the tool. Further, an indication may be obtained that prevents further usage of the workpiece (e.g., because the workpiece is faulty and/or does not match the required quality, because the workpiece has been produced using a certain tool).

Previous solutions often only provide raw operational data. However, analyzing the operation of a manufacturing device requires a lot of pre-processing of the raw data. The present embodiments are intended to close this gap. For example, it is intended to overcome the drawbacks that the recording of operational data was only possible in an uninterrupted and continuous manner and that the operational data thus was not prepared for, for example, training a machine learning model. Further, it was not possible to assign quality data, measuring or pre-setting data, and/or tool data, or status data, in general retrospectively. Further, it was not possible to change a once set trigger or status data. Rather, the processing step (e.g., measurement) was to be re-performed in order to gain the desired augmented (e.g., labelled) operational data.

It is thus proposed as, for example, shown in FIG. 2 to obtain operational data 11 relating to the operation of the manufacturing device (e.g., a machine tool). The operational data 11 may include time series of one or more physical properties of the manufacturing device. Further, status data 12 relating to a component of the manufacturing device (e.g., a tool, also known and referred to as machining tool) may be obtained. The status data 12 may include events relating to and/or characteristic properties relevant for the utilization of the component within the manufacturing device. The operational data and the status data may be received (e.g., at a gateway 21), for example, on an edge device, where the data may be stored and/or further transmitted to a remote storage, such as a database (e.g., in a networked computing infrastructure, such as cloud) of a high-level information system 22.

Turning to FIG. 4, further embodiments are described in the following. The status data 12 may be used for labelling the operational data 11. One or more subsets of the operational data 11 may be labeled by associating one or more of the events and/or characteristic properties to the one or more subsets. Thereby, an augmented data set 13 may be obtained.

The status data may include a tool ID, identifying the instance of a tool. The status data may include master data of the tool, the name of the tool (e.g., in the NC program). The status data may include the location of the tool (e.g., whether the tool is located in a cabinet such as the storage device or assembly container). The status data may include user defined attributes.

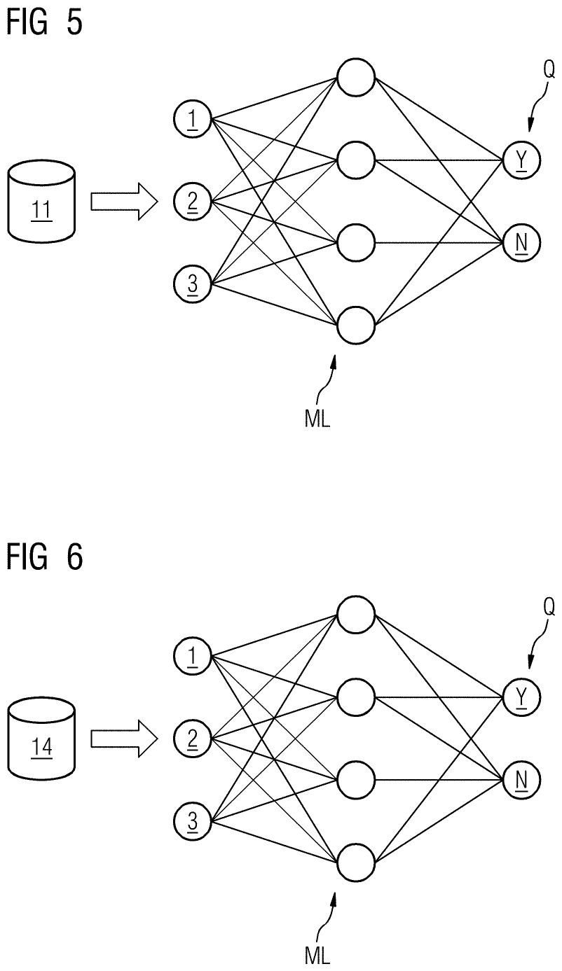

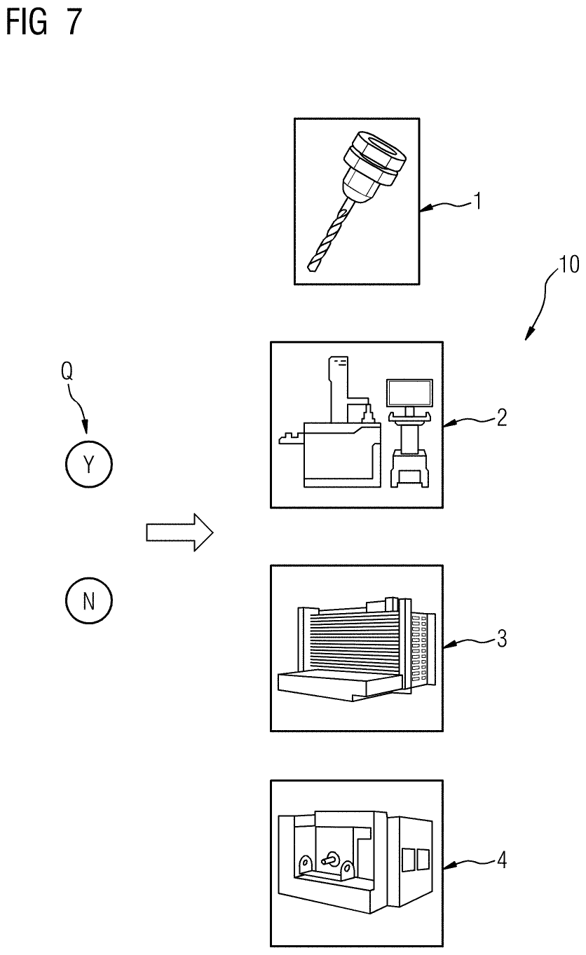

Turning to FIG. 5, further embodiments are described in the following. The one or more subsets of the operational data are provided as labelled training data for training a machine learning model ML. The machine learning model ML serves for outputting a quality indicator based on the labelled training data input. The machine learning model ML takes the operational data as input and serves for outputting a quality indicator Q. The quality indicator Q may represent a nominal or abnormal operation of the manufacturing device (e.g., during a time span during which a certain status applies). The training of the machine learning model ML may take place in the gateway 21 and/or in the higher-level information system 22.

Turning to FIG. 5, further embodiments are described in the following. The trained machine learning model ML may be provided for quality inspection. The newly obtained operational data may be fed into the machine learning model. The previously trained machine learning model may then output a quality indicator Q. The quality indicator Q may indicate whether an anomaly the machine learning model was trained to determine is present in the newly obtained operational data. As shown in FIG. 5, the quality indicator may take on the values Y and N, where Y indicates that there is an anomaly present, and N indicates that there is no anomaly present in the operational data. Hence, a quality indicator may indicate different classifications (e.g., using the labels from the status data; a bad workpiece quality or an exceeded tolerance of the component and/or the workpiece). Thus, one or more labels assigned to (e.g., one or more subsets of) the operational data may be used as a quality indicator of the machine learning model. Hence, the trained machine learning model may classify the operational data input according to the label that has been assigned to (e.g., the one or more subsets of) the operational data that was used as training data. Hence a first classification class (e.g., quality indicator value Y) may indicate that the component has exceeded a predetermined tolerance and a second classification class (e.g., quality indicator N) may indicate that the component has not exceeded the predetermined tolerance. As mentioned before, the status data may be used as a label for the training data. The label may then also be used as a classification class and as an output of the trained machine learning model. The label(s) used for the one or more subsets of the operational data may correspond to the status data that relate to the component of the manufacturing device. Such status data may include, for example, an event relating to and/or a characteristic property relevant for the utilization of the component as mentioned in the above. The execution of the trained machine learning model ML may take place in the gateway 21 and/or in the higher-level information system 22.

Turning to FIG. 6, further embodiments are described in the following. The quality indicator Q, determined by the machine learning model, may subsequently be used to cause one or more further actions relating to the operation of the manufacturing device and/or the component and/or the production system as a whole. For example, the quality indicator Q may be to a user (e.g., by displaying the quality indicator Q to a user on a display screen). Further, an alert may be initiated based on the quality indicator Q (e.g., a notification displayed on a display screen of the manufacturing device). The alert may instead or additionally be displayed to a user in a software application in the cloud. Further, it is possible to prevent, based on the quality indicator Q, further usage of the component. Still further, the quality indicator Q may be used for indicating and/or initiating based on the quality indicator Q a component inspection. Still further, the quality indictor Q may be used to at least temporarily stop, based on the quality indicator, operation of the manufacturing device (e.g., by shutting down the manufacturing device or by changing the operation mode of the manufacturing device).

It is an advantage of the present embodiments that the operational data is divided into individual measurements according to individual triggers. Such triggers may be introduced by a user. A trigger may be an event such as, for example, a tool insertion, and marked by tags. Additional results (e.g., on quality, events, and tool instances) may also be assigned to the individual measurements manually and automatically.

Hence, a computer program (e.g., a software) may include a function to record tool related events that may be used for tool lifecycle management. These recorded events may be used as status data. Hence, the status data may include the start and/or end of an NC program. The status data may include error data (e.g., when a NC program is interrupted). The status data may further include loading and/or unloading of a tool (e.g., in a machine tool). The status data may include a tool change (e.g., when a tool loaded in a spindle of a machine tool is successfully moved). The status data may also include one or more timestamps that are recorded when any of the above events occur. The timestamps are then assigned to the status data.

Filters may be used for limiting the amount of received tool data: The following shows the characters as they are used in the filter options described below. For example, a filter that specifies the time range within which the operational data is recorded. The general format of this filter is: Timestamp<Start time> and Timestamp <End time>.

The operational data may include sensor data, such as data reflecting the operating temperature of a machine tool.

The elements and features recited in the appended claims may be combined in different ways to produce new claims that likewise fall within the scope of the present invention. Thus, whereas the dependent claims appended below depend from only a single independent or dependent claim, it is to be understood that these dependent claims may, alternatively, be made to depend in the alternative from any preceding or following claim, whether independent or dependent. Such new combinations are to be understood as forming a part of the present specification.

While the present invention has been described above by reference to various embodiments, it should be understood that many changes and modifications can be made to the described embodiments. It is therefore intended that the foregoing description be regarded as illustrative rather than limiting, and that it be understood that all equivalents and/or combinations of embodiments are intended to be included in this description.

1. A computer-implemented method for quality inspection of a component of a manufacturing device, the computer-implemented method comprising:
obtaining operational data relating to operation of the manufacturing device, the operational data comprising a time series of one or more physical properties of the manufacturing device;
obtaining status data relating to a component of the manufacturing device, the status data comprising events relating to, characteristic properties relevant for, or events relating to and characteristic properties relevant for utilization of the component within the manufacturing device;
labelling one or more subsets of the operational data, the labelling comprising associating one or more of the events, the characteristic properties, or the events and the characteristic properties to the one or more subsets;
providing the one or more subsets as labelled training data for training a machine learning model, wherein the machine learning model serves for outputting a quality indicator based on the labelled training data input; and
providing the trained machine learning model for quality inspection.

2. The computer-implemented method of claim 1, further comprising:
creating a query comprising at least one first condition for the operational data and at least one second condition for the status data; and
retrieving, based on the query, one or more subsets of the operational data fulfilling the at least one first condition and falling within a time span during which the at least one second condition is fulfilled by the status data.

3. The computer-implemented method of claim 1, further comprising:
providing the quality indicator to a user;
initiating, based on the quality indicator, an alert;
preventing, based on the quality indicator, further usage of the component;
indicating/initiating, based on the quality indicator, a component inspection;
at least temporarily stopping, based on the quality indicator, operation of the manufacturing device; or
any combination thereof.

4. The computer-implemented method of claim 3, further comprising initiating, based on the quality indicator, the alert,
wherein the alert comprises a notification displayed on a display screen of the manufacturing device to a user or an app in a cloud.

5. The computer-implemented method of claim 2, further comprising:
recording, by the manufacturing device, a time stamp with each data item of the time series of the operational data;
transmitting, by a first client communicatively coupled to the manufacturing device, the operational data to a first server and storing the time series in a first database communicatively coupled to the first server; and
recording, by a second client, a time stamp with each event of the status data, and transmitting the events to a second server and storing the status data in a second database communicatively coupled to the second server.

6. The computer-implemented method of claim 5, further comprising:
querying the first database based on a first part of the query comprising the at least one first condition; and
querying the first database or a third database based on a second part of the query comprising the at least one second condition.

7. The computer-implemented method of claim 2, further comprising:
identifying concurrent time spans within the operational data and the status data fulfilling the at least one first condition and the at least one second condition of the query, respectively.

8. An apparatus comprising:
a memory; and
a processor configured for quality inspection of a component of a manufacturing device, wherein the processor being configured for quality inspection of the component comprises the processor being configured to:
obtain operational data relating to operation of the manufacturing device, the operational data comprising a time series of one or more physical properties of the manufacturing device;
obtain status data relating to a component of the manufacturing device, the status data comprising events relating to, characteristic properties relevant for, or events relating to and characteristic properties relevant for utilization of the component within the manufacturing device;
label one or more subsets of the operational data, the label of the one or more subsets of the operational data comprising associating one or more of the events, the characteristic properties, or the events and the characteristic properties to the one or more subsets;
provide the one or more subsets as labelled training data for training a machine learning model, wherein the machine learning model is configured to output a quality indicator based on the labelled training data input; and
provide the trained machine learning model for quality inspection.

9. The apparatus of claim 8, further comprising:
a machine tool comprising a first client configured to provide the operational data to a server, implemented in hardware, software, or hardware and software; and
a tool management system configured in software, the tool management system being configured to provide the status data to the server.

10. In a non-transitory computer-readable storage medium that stores instructions executable by one or more processors for quality inspection of a component of a manufacturing device, the instructions comprising:
obtaining operational data relating to operation of the manufacturing device, the operational data comprising a time series of one or more physical properties of the manufacturing device;
obtaining status data relating to a component of the manufacturing device, the status data comprising events relating to, characteristic properties relevant for, or events relating to and characteristic properties relevant for utilization of the component within the manufacturing device;
labelling one or more subsets of the operational data, the labelling comprising associating one or more of the events, the characteristic properties, or the events and the characteristic properties to the one or more subsets;
providing the one or more subsets as labelled training data for training a machine learning model, wherein the machine learning model serves for outputting a quality indicator based on the labelled training data input; and
providing the trained machine learning model for quality inspection.

11. The non-transitory computer-readable storage medium of claim 10, wherein the instructions further comprise:
creating a query comprising at least one first condition for the operational data and at least one second condition for the status data; and
retrieving, based on the query, one or more subsets of the operational data fulfilling the at least one first condition and falling within a time span during which the at least one second condition is fulfilled by the status data.

12. The non-transitory computer-readable storage medium of claim 11, wherein the instructions further comprise:
providing the quality indicator to a user;
initiating, based on the quality indicator, an alert;
preventing, based on the quality indicator, further usage of the component;
indicating/initiating, based on the quality indicator, a component inspection;
at least temporarily stopping, based on the quality indicator, operation of the manufacturing device; or
any combination thereof.

13. The non-transitory computer-readable storage medium of claim 12, wherein the instructions further comprise initiating, based on the quality indicator, the alert,
wherein the alert comprises a notification displayed on a display screen of the manufacturing device to a user or an app in a cloud.

14. The non-transitory computer-readable storage medium of claim 11, wherein the instructions further comprise:
recording, by the manufacturing device, a time stamp with each data item of the time series of the operational data;
transmitting, by a first client communicatively coupled to the manufacturing device, the operational data to a first server and storing the time series in a first database communicatively coupled to the first server; and
recording, by a second client, a time stamp with each event of the status data, and transmitting the events to a second server and storing the status data in a second database communicatively coupled to the second server.

15. The non-transitory computer-readable storage medium of claim 14, wherein the instructions further comprise:
querying the first database based on a first part of the query comprising the at least one first condition; and
querying the first database or a third database based on a second part of the query comprising the at least one second condition.

16. The non-transitory computer-readable storage medium of claim 11, wherein the instructions further comprise:
identifying concurrent time spans within the operational data and the status data fulfilling the at least one first condition and the at least one second condition of the query, respectively.
